(19) United States
(12) Patent Application Publication
(10) Pub. No.: US 2016/0112672 A1
(43) Pub. Date: Apr. 21, 2016

(54) METHOD AND SYSTEM FOR REMOTE HUMAN MICRO-INTERATIONS

(71) Applicant: RF Spot, Inc., Moffett Field, CA (US)

(72) Inventor: Andrew Joseph GOLD, Mountain View, CA (US)

(21) Appl. No.: 14/919,019

(22) Filed: Oct. 21, 2015

Related U.S. Application Data
(60) Provisional application No. 62/066,705, filed on Oct. 21, 2014.

(51) Int. Cl. H04N 7/14; H04L 29/06; H04N 7/15

(52) U.S. Cl. CPC H04N 7/142; H04N 7/15; H04N 7/147; H04L 65/403

(57) ABSTRACT

A system and method rely on a database having stored therein records relating to each a plurality of responders and having stored therein an indication of a field of expertise. User interface systems are registered with the system such that a query provided in association with a location or with a specific user interface system is analysed and a suitable responder is located from within the records of the database. A communication session between said responder and a provider of said query is then automatically established.

### CROSS-REFERENCES TO RELATED APPLICATIONS

This application claims the benefit of U.S. Provisional Patent Application No. 62/066,705, filed Oct. 21, 2014, and incorporates the disclosure of the application by reference.

### BACKGROUND

In the 18^{th} century, experts were few and far between and people traveled long distances to meet with and learn from experts. Because experts published books or research articles on their area of expertise, they were both easy to identify and easy to locate. This continues to the present day. An expert is usually identified based on their writing, their research, or their achievements. Once these are widely known, people seek out the experts in person, by mail, by telephone and by email. Unfortunately, many of these experts are very busy and therefore are not easily reached on a moments notice, thereby having a similar drawback to that of 200 years ago.

It would be advantageous to provide a system and method that overcomes at least some of the disadvantages of the prior art.

### SUMMARY

In accordance with an embodiment of the invention there is provided a method comprising: providing a first user interface system, a second user interface system, and a third user interface system coupled for communication therebetween via a communication network, the second user interface system and the third user interface system each comprising a mobile telepresence system including a display, a camera and at least an actuator for moving the display and the camera, the actuator for being controlled from a remote system via the communication network; initiating a first communication session between the first user interface system and the second user interface system, the first communication session for transmitting control data from the first user interface system for controlling the actuator of the second user interface system, data for video communication between the first user interface system and the second user interface system and data for audio communication between the first user interface system and the second user interface system; and switching the first communication session from between the first user interface system and the second user interface system to a second communication session between the first user interface system and third user interface system, the second communication session for transmitting control data from the first user interface system for controlling the actuator of the third user interface system, data for video communication between the first user interface system and the third user interface system and data for audio communication between the first user interface system and the third user interface system.

In accordance with another embodiment of the invention there is provided a method comprising: providing a first user interface system and second user interface system coupled for communication therebetween via a communication network; providing a database of available users, associated user interface systems each associated with an available user of the available users, and expertise of each of the available users; requesting at the second user interface system a response to a first query; determining a first user interface system based on the expertise of each of the available users, a user and the associated user interface system associated with the user to provide a response to the first query, the first user interface system comprising the associated user interface system associated with the user; automatically initiating a data communication session for human communication between the second user interface system and the first user interface system; transmitting data between the first user interface system and the second user interface system for forming human intelligible communication for responding to the query; and, once the query has been responded to, releasing the communication session.

In accordance with another embodiment of the invention there is provided a method comprising: providing a plurality of user interface systems distributed in a plurality of locations each coupled for communication therebetween via a communication display and transducer communication network; providing a database of available users, associated user interface systems each associated with an available user, and expertise data associated with each of the available users; requesting at a first user interface system a response to a first query; requesting at a second other user interface system a response to a second query; determining based on the expertise data, a first respondent and the associated system associated with the first respondent to provide a response to the first query; determining based on the expertise data, a second respondent and the associated system associated with the second respondent to provide a response to the second query; automatically initiating a first human communication session between the second system and the associated system associated with the first respondent; automatically initiating a second human communication session between the second system and the associated system associated with the second respondent; transmitting data between the first user interface system and the system associated with the first respondent for forming human intelligible communication; and transmitting data between the second user interface system and the system associated with the second respondent for forming human intelligible communication.

In accordance with another aspect of an embodiment of the invention there is provided a system comprising: a database having stored therein records relating to each a plurality of responders and having stored therein an indication of a field of expertise; a plurality of user interface systems in communication via a communication network; and a processor for receiving queries, for determining based on contents of the database a suitable responder for responding to a particular query and for automatically establishing a communication session between said responder and a provider of said query.

### BRIEF DESCRIPTION OF THE DRAWINGS

The instant invention will now be described by way of example only, and with reference to the attached drawings, wherein similar reference numerals denote similar elements throughout the several views, and in which:

FIG. 1 is a simplified block diagram showing a wide area network (WAN) for supporting embodiments of the present invention;

FIG. 2 is a simplified flow diagram of a method of setting up a video call according to the prior art;

FIG. 3 is a simplified flow diagram of a method of setting up a telepresence communication system according to the prior art;

FIG. 4 is a simplified diagram of a wide area network having a plurality of locations and systems distributed and coupled thereto;

FIG. 5 is a simplified flow diagram of a method according to an embodiment for initiating a communication session between two parties;

FIG. 6 is a simplified flow diagram of a method according to an embodiment for initiating a communication session between two parties;

FIG. 7 is a simplified flow diagram of a method according to an embodiment for initiating a communication session between two parties;

FIG. 8 is a simplified flow diagram of a method according to an embodiment for initiating a communication session between two parties; and,

FIG. 9 is a simplified flow diagram of a method according to an embodiment for initiating a communication session between two parties.

### DETAILED DESCRIPTION OF THE DRAWINGS

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

The following terms are used in accordance with the definitions set out hereinbelow:

“User interface system” in defined as a system providing a user with an ability to enter data and/or receive data from a communication network. Non limiting examples of user interface systems include computers, terminals, smartphones, tablets, and telepresence systems.

“Telepresence system” is defined as a system allowing a person at a remote location to interface with a person remote therefrom as if they were at the location of the person. Telepresence systems include static telepresence systems and mobile telepresence systems.

“Mobile telepresence system” comprise moving parts that are controllable from a remote location allowing the telepresence system to move. Some mobile telepresence systems move on wheels from one location to another. Other mobile telepresence systems move between different configurations, for example the monitor moves relative to a base thereof or an arm moves. Of note, movement of mobile telepresence systems is controlled at least in part via a remote interface. Mobile telepresence systems include stationary moving telepresence systems and ambulatory telepresence systems.

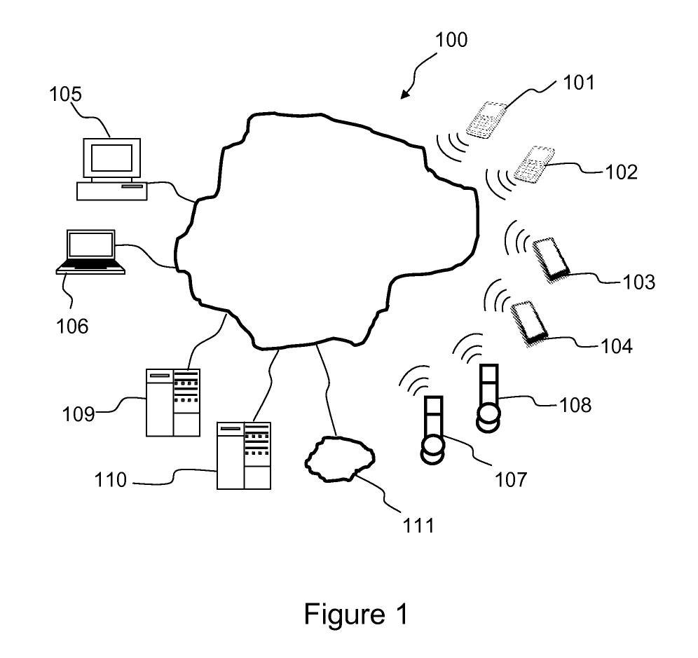

Referring to FIG. 1, shown is wide area network in the form of Internet 100. Coupled to the Internet 100 by way or wired connection, optical connection, wireless connection, or via a communication network(s) and/or a gateway(s) are a plurality of user interface systems including mobile phones 101 and 102, tablets 103 and 104, personal computers 105 and 106, telepresence systems 107 and 108, servers 109 and 110, and cloud system 111. Each of the devices 101-111 communicates via the Internet 100 with any of the other devices allowing for a broad range of communication sessions and options. Though only two of each device is shown in FIG. 1, it is clear to those of skill in the art that the Internet comprises many thousands of each system distributed around the globe.

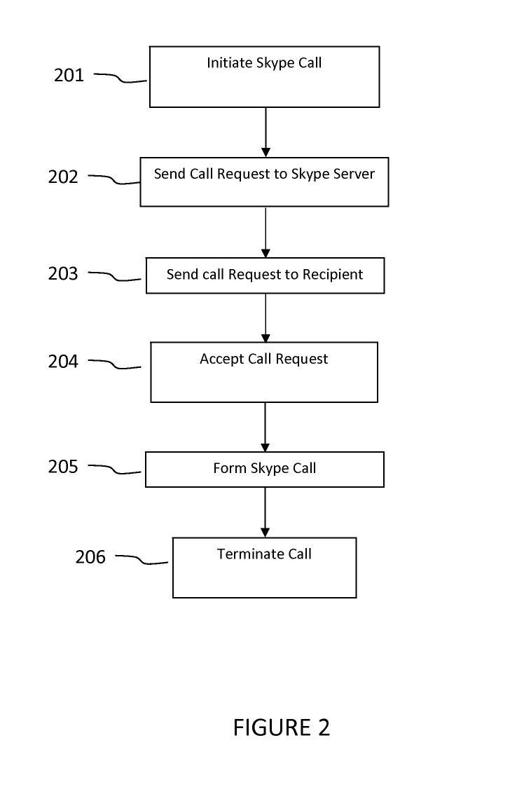

Skype has changed the way that people communicate. Whereas 20 years ago, the thought of video conferencing was futuristic and involved specialized video conferencing hardware, Skype changed that by bringing video conferencing to every personal computer. Relying on the Internet as a switching communication network, Skype allows people to communicate using video communication from nearly anywhere. Referring To FIG. 2, shown is a simplified flow diagram of a method of conducting a Skype call. At 201, a user of a User Interface System in the form of personal computer 105 attempts to initiate a Skype call with another user having a destination Skype account. The personal computer 105 transmits via the Internet a request destined for the destination Skype account at 202. A Skype server routes the request to a second user interface system having a Skype application in execution and with the destination Skype account logged in thereto at 203. At 204, a user of the second user interface system accepts the request and at 205 a Skype call is initiated. At 206, the call is terminated.

Thus, using this simple methodology allows people to communicate one with another using voice or video and voice so long as both the initiator of the call and the recipient are logged into their Skype accounts and each has access to a user interface system.

One drawback to Skype is that it requires a user to be at their computer to receive a call. Of course, today computers include mobile smart phones and tablets and as such many people are always accessible, that said, if you are on an assembly line, answering a skype call would be difficult. A second problem with Skype is that it is difficult to use Skype and to work at the same time because Skype takes up significant real estate on the computer monitor of each party to a call.

In response to these problems, Mobile telepresence systems have been created. With a Mobile telepresence system in the form of a telepresence robot, a user video conferences into a Mobile telepresence system and controls movement of the Mobile telepresence system. Thus, the user can move around from person to person, speak with a group of people, attend meetings, etc. all using a video conferencing and motion control interface. This allows users greater flexibility and also allows the person interacting with the Mobile telepresence system to use their computer as the Mobile telepresence system uses a separate display, microphone and speaker. Thus, using a Mobile telepresence system results in a much more natural experience for the person or people interacting therewith.

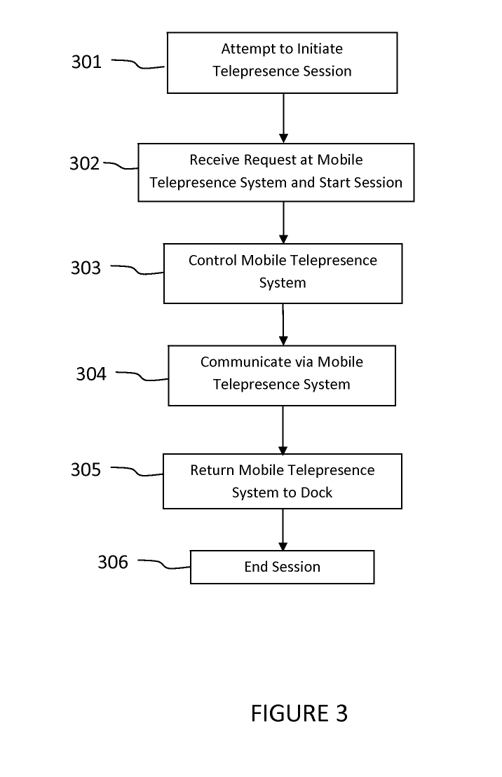

Referring to FIG. 3, shown is a simplified flow diagram of a method of conducting a telepresence call. At 301, a user of a User Interface System in the form of personal computer 105 attempts to initiate a telepresence call with a telepresence system at a remote known location. The personal computer 105 transmits via the Internet a request destined for the telepresence system. The telepresence system receives the request and at 302 a telepresence session is initiated. At 303, the user of the user interface system 105 controls the telepresence system 107 to move it around. Further at 304, the user of the user interface system 105 communicates via a display of telepresence system 107 with other people in a vicinity of the telepresence system 107. At 305, the telepresence system is returned to its original resting location and at 306, the telepresence session is terminated.

Thus, relying on a telepresence system such as the telepresence system 107 allows for a single communication session with several individuals and allows for mobility within a video conference session.

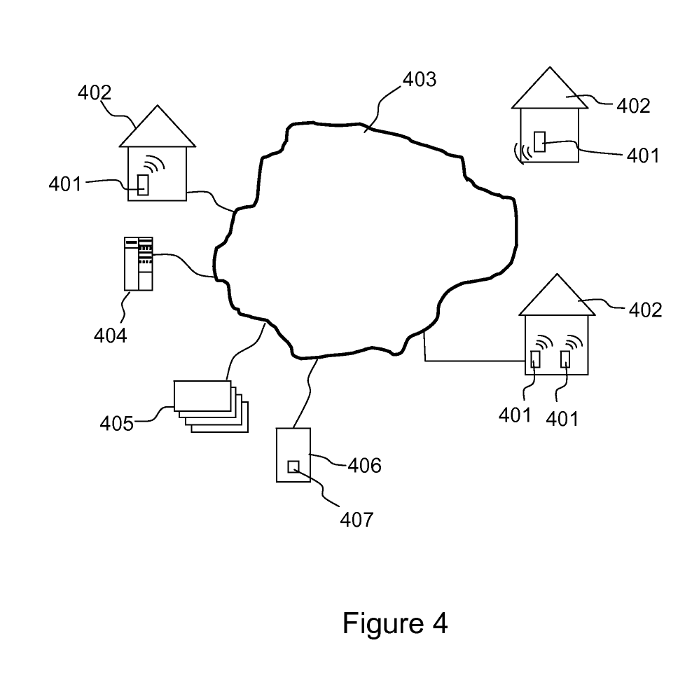

Referring to FIG. 4, a simplified system diagram is shown for a communication network. A plurality of user interface systems 401 in the form of telepresence systems 107, 108 are disposed in a plurality of known locations 402. Each telepresence system is registered with the communication network server 404 via a communication network 403 in the form of the Internet, which controls its communication. A database 405 is coupled with the communication network comprising data relating to subject matter experts, user interface systems being used by those subject matter experts, availability of each subject matter expert, and other relevant data relating to each subject matter expert such as languages spoken, etc. A controller 406 coupled to the communication network includes a processor 407 for searching the database and for determining a best suited available expert to respond to a given query. A the controller or alternatively a further system (Not Shown) allows for query analysis to determine a type of expertise for responding to a particular query. The controller is optionally automated. Alternatively, the further system relies on people to decipher and categorize each query. Once a query is categorized, searching for experts in that category and filtering based on availability allows for expert selection. Once selected, the expert is provided via the communication network 403 to the telepresence system 401 to reply to the specific query and to communicate with a provider of the query at the known location 402. At anytime, a telepresence system can be added or removed and an expert can log in or log out of the system, for example via a user interface system such as a PC or smartphone. Thus, the available experts and the queries provided form an ever-changing landscape.

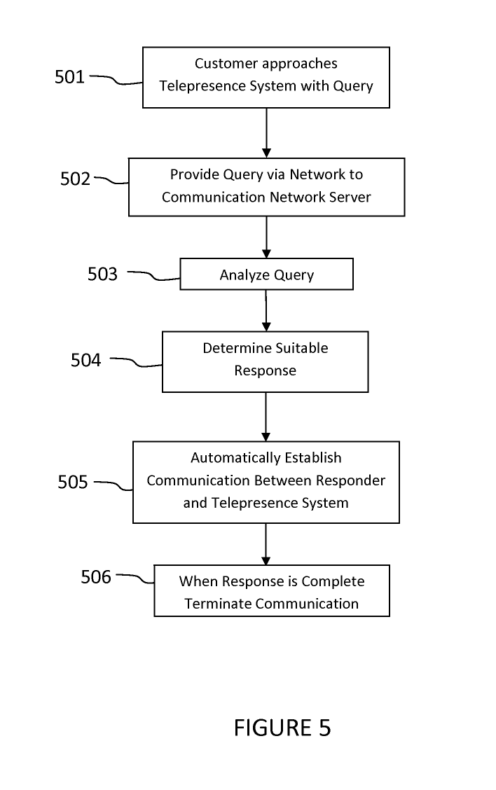

Referring to FIG. 5, shown is a simplified flow diagram for an interaction with the communication network of FIG. 4. A customer approaches a telepresence system with a query at 501. The query is provided to the communication network server at 502, either through another user interface system or via an available telepresence system. The query is provided for analysis at 503 and based on at least one of the query type, the telepresence system location, and the person providing the query, at 504 a database is searched to locate a suitable responder for responding to the query. Automatically at 505, a communication channel is created between the responder and the user to allow for a communication both about the query and in response thereto. When the query is adequately responded to, the communication channel is terminated at 506.

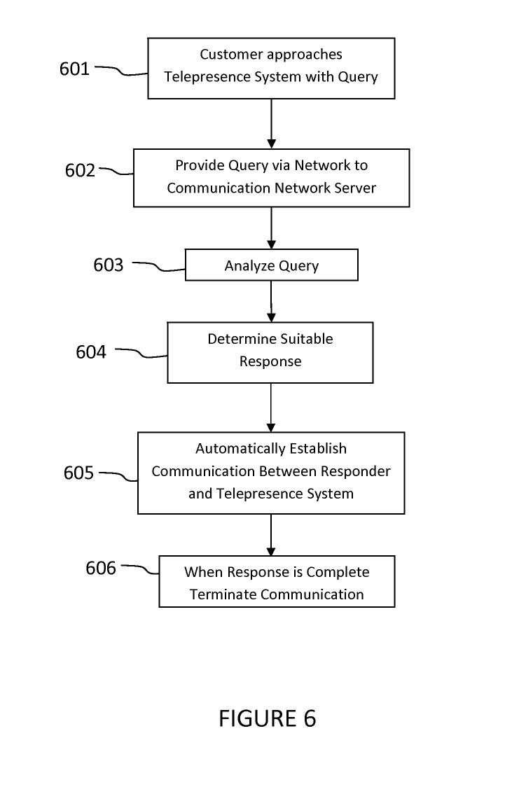

Referring to FIG. 6, shown is a simplified flow diagram for an interaction with the communication network of FIG. 4 for one expert. The expert signs in to a user interface system at 601. At 602, the expert is connected to a first user via the communication network and via the telepresence system 107. A user query is reviewed and responded to at 603. When the communication is completed, the expert terminates the communication session at 604 only to be connected at 605 with a next user, a second other telepresence system, either in a same or different remote location. The expert then answers that user's query at 603. When that communication is completed, the expert terminates the communication session at 604 only to be connected at 605 with another next user via another telepresence system, either in a same or different remote location. In this way, a single expert supports many locations and answers questions on topics that they are qualified to answer. Advantageously, because an expert serves many locations, they can be highly specialized and can provide specialized advise to a large audience.

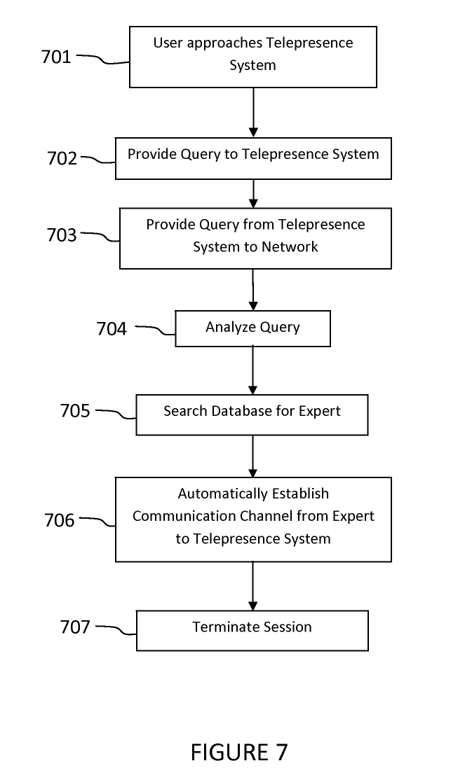

Referring to FIG. 7, shown is a simplified flow diagram for the system as seen from a single user interface system in the form of a telepresence system. A user approaches a telepresence system at 701 and provides a query thereto at 702. The query is provided to the communication network at 703, either through another user interface system or via an available telepresence system. The query is provided for analysis at 704 and based on at least one of the query type, the telepresence system location, and the person providing the query, at 705 a database is searched to locate a suitable responder for responding to the query. Automatically at 706, a communication channel is created between the responder and the user to allow for a communication both about the query and in response thereto. When the query is adequately responded to, the communication channel is terminated at 707. Once terminated, the process recommences at 701 with another user approaching the telepresence system with a second query. The second query is provided to the communication network at 703, either through another user interface system or via the telepresence system. The second query is provided for analysis at 709 and based on at least one of the second query type, the telepresence system location, and the person providing the second query, at 705 the database is searched again to locate a second suitable responder for responding to the second query. Automatically at 706, another communication channel is created between the second responder and the telepresence system to allow for a communication both about the second query and in response thereto. When the second query is adequately responded to, the second communication channel is terminated.

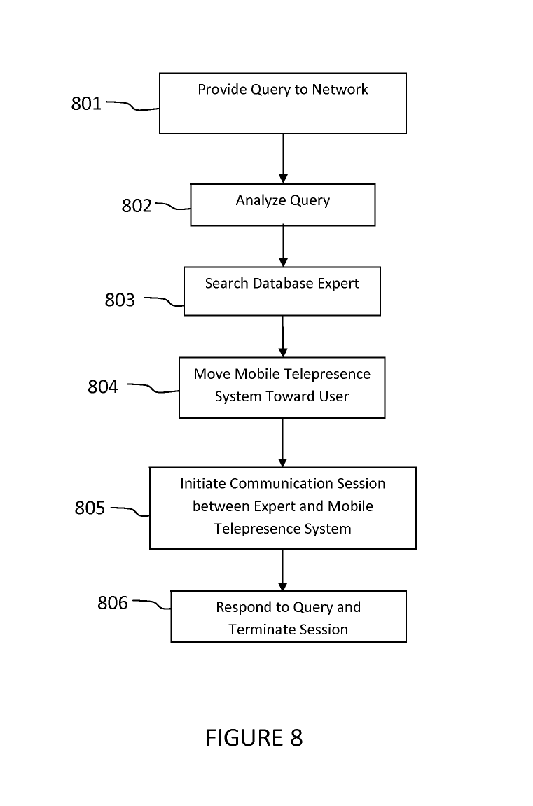

Referring to FIG. 8, shown is an embodiment of the system as seen from a single user interface system in the form of a mobile telepresence system. A user provides a query to the communication network at 801, either through another user interface system or via an available telepresence system. The query is provided for analysis at 802 and based on at least one of the query type, the user location, and the person providing the query, at 803 a database is searched to locate a suitable responder for responding to the query. Automatically at 804, a mobile telepresence system is controlled to move the mobile telepresence system to a location proximate the user. At 805, a communication channel is created between the responder and the mobile telepresence system to allow for a communication both about the query and in response thereto. When the query is adequately responded to, the communication channel is terminated at 806.

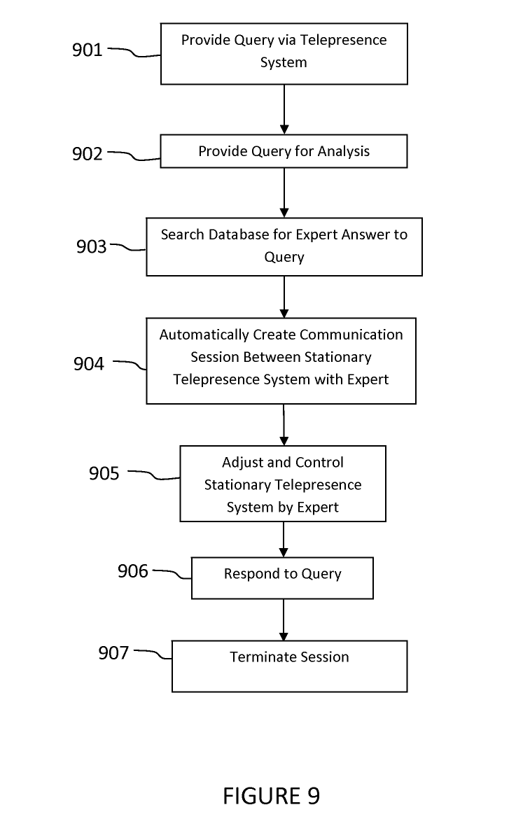

Referring to FIG. 9, shown is an embodiment of the system as seen from a single user interface system in the form of a stationary telepresence system. A user provides a query to the communication network at 901 via a telepresence system that is stationary but can be controlled to move, for example to rotate on a base. The query is provided for analysis at 902 and based on at least one of the query type, the user location, and the person providing the query, at 903 a database is searched to locate a suitable responder for responding to the query. Automatically at 905, a communication channel is created between the responder and the telepresence system to allow for a communication both about the query and in response thereto. During the communication, the responder controls the telepresence system to adjust same at 906. For example, a display of the telepresence system is rotated in order to look in different directions. Alternatively, an arm of the telepresence system is moved to point at something or to hold something. When the query is adequately responded to at 907, the communication channel is terminated at 908.

For example, a system such as that described with reference to FIG. 9 is useful for reception wherein the system allows for rotating vision and interaction in each of several directions and allows a single receptionist to manage multiple reception systems at different locations. Alternatively, the system is used in a specialized reception such as at a car dealership allowing checking in of automobiles without persistent presence of staff at the check-in counter. A remote receptionist can manage each customer and, as customers show up, a check-in specialist is routed to a particular counter. This allows for better crowd management across many dealerships. Further, it takes advantage of time zone changes as reception is busier at some times than others and thus sharing with dealerships in different time zones shares the workload with other businesses that are busy at different times during a same day.

In another implementation, the system is used in retail businesses wherein experts for different departments can be routed to different stores as needed allowing for a more efficient allocation of experts amongst many retail locations based on overall need. Similarly, some items that require additional sales expertise are manageable without each and every sales associate receiving training simply by connecting a sales expert through the system described herein to a potential customer.

Numerous other embodiments may be envisaged without departing form the spirit or scope of the invention.

What is claimed is:

1. A method comprising:
providing a first user interface system, a second user interface system, and a third user interface system coupled for communication therebetween via a communication network, the second user interface system and the third user interface system each comprising a mobile telepresence system including a display, a camera and at least an actuator for moving the display and the camera, the actuator for being controlled from a remote system via the communication network;
initiating a first communication session between the first user interface system and the second user interface system, the first communication session for transmitting control data from the first user interface system for controlling the actuator of the second user interface system, data for video communication between the first user interface system and the second user interface system and data for audio communication between the first user interface system and the second user interface system; and
switching the first communication session from between the first user interface system and the second user interface system to a second communication session between the first user interface system and third user interface system, the second communication session for transmitting control data from the first user interface system for controlling the actuator of the third user interface system, data for video communication between the first user interface system and the third user interface system and data for audio communication between the first user interface system and the third user interface system.

2. A method according to claim 1, wherein switching is performed automatically absent a step of a user of the first user interface system selecting the third user interface system for communication therewith.

3. A method according to claim 1, wherein switching is performed in response to terminating the first communication session and wherein the third user interface system for communication therewith is selected absent control of the user of the first user interface system.

4. A method according to claim 3, wherein the third user interface system for communication therewith is selected by:
providing a first query by a user of the third user interface system, and determining that a user of the first user interface system is appropriate for responding to the first query.

5. A method according to claim 4, further comprising initiating the switching in response to a user of the second user interface system indicating a query and a determination that the query is satisfactorily responded to.

6. A method according to claim 1, further comprising:
providing from a customer a query via the communication network, the query for being responded to;
analyzing the query to determine a responder for responding to the query;
when the responder is the user of the first user interface system, moving the second user interface system into proximity of the customer; and
when the responder is the user of the first user interface system, initiating the first communication session.

7. A method comprising:
providing a first user interface system and second user interface system coupled for communication therebetween via a communication network;
providing a database of available users, associated user interface systems each associated with an available user of the available users, and expertise of each of the available users;
requesting at the second user interface system a response to a first query;
determining a first user interface system based on the expertise of each of the available users, a user and the associated user interface system associated with the user to provide a response to the first query, the first user interface system comprising the associated user interface system associated with the user;
automatically initiating a data communication session for human communication between the second user interface system and the first user interface system;
transmitting data between the first user interface system and the second user interface system for forming human intelligible communication for responding to the query; and,
once the query has been responded to, releasing the communication session.

8. A method according to claim 7, wherein the second user interface system comprises a display and transducer controllable from a remote location via the communication network and from which communication data is received.

9. A method according to claim 8, wherein the display and transducer forms part of a telepresence system controllable from a remote location via the communication network and from which communication data is received.

10. A method according to claim 9, wherein the telepresence system forms part of a mobile telepresence system, the entire telepresence system for moving from the first location to the second other location.

11. A method according to claim 9, wherein the telepresence system comprises at least a movable component for being controllably moved relative to other components of the telepresence system, some parts of the telepresence system for remaining stationary and other parts for being controllably moved.

12. A method comprising:
providing a plurality of user interface systems distributed in a plurality of locations each coupled for communication therebetween via a communication display and transducer communication network;
providing a database of available users, associated user interface systems each associated with an available user, and expertise data associated with each of the available users;
requesting at a first user interface system a response to a first query;
requesting at a second other user interface system a response to a second query;
determining based on the expertise data, a first respondent and the associated system associated with the first respondent to provide a response to the first query;
determining based on the expertise data, a second respondent and the associated system associated with the second respondent to provide a response to the second query;
automatically initiating a first human communication session between the second system and the associated system associated with the first respondent;
automatically initiating a second human communication session between the second system and the associated system associated with the second respondent;
transmitting data between the first user interface system and the system associated with the first respondent for forming human intelligible communication; and
transmitting data between the second user interface system and the system associated with the second respondent for forming human intelligible communication.

13. The method according to claim 12, further comprising upon responding to the first query releasing the first human communication session and automatically initiating another human communication session.

14. The method according to claim 13, further comprising upon responding to the second query releasing the second human communication session and automatically initiating another human communication session.

15. A method according to claim 12, wherein the first respondent and the second respondent are in different locations, one remote from another.

16. A method according to claim 15, wherein the first query and the second query are provided at remote locations one from another.

17. A method according to claim 12, further comprising updating the database of available users by adding an available user when a user signs in and by removing an available user when a user signs out, the database of available users reflecting those users who have indicated their present availability to respond to a query.

18. A method according to claim 17, further comprising updating the database by storing therein an indication of a number of queries responded to by each respondent.

19. A method according to claim 17, further comprising updating the database by storing therein an indication of an amount of time spent responding to queries by respondent.

20. A system comprising:
a database having stored therein records relating to each a plurality of responders and having stored therein an indication of a field of expertise;
a plurality of user interface systems in communication via a communication network; and
a processor for receiving queries, for determining based on contents of the database a suitable responder for responding to a particular query and for automatically establishing a communication session between said responder and a provider of said query.
